(19) United States
(12) Patent Application Publication
(10) Pub. No.: US 2026/0253310 A1
(43) Pub. Date: Aug. 27, 2026

(54) USING GAUSSIAN PRIMITIVES WHEN GENERATING BIRD’S EYE VIEW REPRESENTATIONS

(71) Applicant: QUALCOMM Incorporated, San Diego, CA (US)

(72) Inventors: Varun Ravi Kumar, San Diego, CA (US); Shubhankar Mangesh Borse, San Diego, CA (US); Senthil Kumar Yogamani, San Diego, CA (US)

(21) Appl. No.: 19/060,279

(22) Filed: Feb. 21, 2025

(51) Int. Cl. G06T 15/08

(52) U.S. Cl. CPC G06T 15/08

(57) ABSTRACT

An example device for generating a bird's-eye view (BEV) representation of objects through processing of media data, such as image data and point cloud data, includes a processing system configured to receive, from a multi-camera system of a vehicle, one or more images of a three-dimensional space around the vehicle; receive, from a depth sensing unit of the vehicle, point cloud data representing the three-dimensional space; form an initial bird's eye view (BEV) representation of the three-dimensional space from the one or more images and the point cloud data; generate Gaussian primitives using the initial BEV representation, the Gaussian primitives representing features of objects in the three-dimensional space; and combine the Gaussian primitives into the BEV representation using Gaussian splatting to form an enhanced BEV representation of the three-dimensional space.

### TECHNICAL FIELD

This disclosure relates to computer vision systems, such as autonomous driving and assistance (ADAS) systems.

### BACKGROUND

Techniques are being researched and developed related to autonomous driving and advanced driving assistance systems. For example, artificial intelligence and machine learning (AI/ML) systems are being developed and trained to determine how best to operate a vehicle according to applicable traffic laws, safety guidelines, external objects, roads, and the like. Using cameras to collect images, depth estimation is performed to determine depths of objects in the images. Depth estimation can be performed by leveraging various principles, such as calibrated stereo imaging systems and multi-view imaging systems.

Various techniques have been used to perform depth estimation. For example, test-time refinement techniques include applying an entire training pipeline to test frames to update network parameters, which necessitates costly multiple forward and backward passes. Temporal convolutional neural networks rely on stacking of input frames in the channel dimension and bank on the ability of convolutional neural networks to effectively process input channels. Recurrent neural networks may process multiple frames during training, which is computationally demanding due to the need to extract features from multiple frames in a sequence and does not reason about geometry during inference. Techniques using an end-to-end cost volume to aggregate information during training are more efficient than test-time refinement and recurrent approaches, but are still non-trivial and difficult to map to hardware implementations.

### SUMMARY

In general, this disclosure describes techniques for determining positions of objects in a real-world environment in a bird's eye view (BEV) representation using images and a depth sensing unit, such as a light detection and ranging (LIDAR) unit, which may generate point cloud data representing the real-world environment. One or more images and point cloud are captured, e.g., at a given time. Features are extracted from the one or more images and the point cloud, and fused to form an initial (fused) BEV representation. Gaussian primitives may then be generated for the features, where the Gaussian primitives may include data representing a position of a feature (a mean value) and a covariance, e.g., a covariance matrix, representing an uncertainty around the mean value. The Gaussian primitives may then be combined with the initial BEV representation to form an enhanced BEV representation. In general, Gaussian primitives may be more tolerant to uncertainty that may arise from camera and LIDAR data due to sensor noise, occlusions, or incomplete views. Because Gaussian primitives naturally capture such uncertainty by explicitly modeling spatial variance, the Gaussian primitive-enhanced BEV representation may more accurately represent the real-world environment.

In one example, a method of processing image and depth data includes: receiving, from a multi-camera system of a vehicle, one or more images of a three-dimensional space around the vehicle; receiving, from a depth sensing unit of the vehicle, point cloud data representing the three-dimensional space; forming an initial bird's eye view (BEV) representation of the three-dimensional space from the one or more images and the point cloud data; generating Gaussian primitives using the initial BEV representation, the Gaussian primitives representing features of objects in the three-dimensional space; and combining the Gaussian primitives with the initial BEV representation using Gaussian splatting to form an enhanced BEV representation of the three-dimensional space.

In another example, a device for processing image and depth data includes: a memory for storing media data; and a processing system comprising one or more processors implemented in circuitry, the processing system being configured to: receive, from a multi-camera system of a vehicle, one or more images of a three-dimensional space around the vehicle; receive, from a depth sensing unit of the vehicle, point cloud data representing the three-dimensional space; form an initial bird's eye view (BEV) representation of the three-dimensional space from the one or more images and the point cloud data; generate Gaussian primitives using the initial BEV representation, the Gaussian primitives representing features of objects in the three-dimensional space; and combine the Gaussian primitives into the BEV representation using Gaussian splatting to form an enhanced BEV representation of the three-dimensional space.

In another example, a device for processing media data includes: means for receiving, from a multi-camera system of a vehicle, one or more images of a three-dimensional space around the vehicle; means for receiving, from a depth sensing unit of the vehicle, point cloud data representing the three-dimensional space; means for forming an initial bird's eye view (BEV) representation of the three-dimensional space from the one or more images and the point cloud data; means for generating Gaussian primitives using the initial BEV representation, the Gaussian primitives representing features of objects in the three-dimensional space; and means for combining the Gaussian primitives into the initial BEV representation using Gaussian splatting to form an enhanced BEV representation of the three-dimensional space.

In another example, a method of processing media data includes receiving sensor input from a set of sensors, the sensor input including one or more images of a three-dimensional space around the set of sensors and a point cloud representation of the three-dimensional space; forming a fused bird's eye view (BEV) representation of the three-dimensional space from the one or more images and the point cloud representation; generating Gaussian primitives using the fused BEV representation, the Gaussian primitives representing objects in the three-dimensional space; and projecting the Gaussian primitives into the BEV representation using Gaussian splatting to form an enhanced BEV representation of the three-dimensional space.

In another example, a device for processing media data includes a memory for storing media data; and a processing system comprising one or more processors implemented in circuitry, the processing system being configured to: receive sensor input from a set of sensors, the sensor input including one or more images of a three-dimensional space around the set of sensors and a point cloud representation of the three-dimensional space; form a fused bird's eye view (BEV) representation of the three-dimensional space from the one or more images and the point cloud representation; generate Gaussian primitives using the fused BEV representation, the Gaussian primitives representing objects in the three-dimensional space; and project the Gaussian primitives into the BEV representation using Gaussian splatting to form an enhanced BEV representation of the three-dimensional space.

In another example, a device for processing media data includes means for receiving sensor input from a set of sensors, the sensor input including one or more images of a three-dimensional space around the set of sensors and a point cloud representation of the three-dimensional space; means for forming a fused bird's eye view (BEV) representation of the three-dimensional space from the one or more images and the point cloud representation; means for generating Gaussian primitives using the fused BEV representation, the Gaussian primitives representing objects in the three-dimensional space; and means for projecting the Gaussian primitives into the BEV representation using Gaussian splatting to form an enhanced BEV representation of the three-dimensional space.

In another example, a computer-readable storage medium has stored thereon instructions that, when executed, cause a processing system to receive sensor input from a set of sensors, the sensor input including one or more images of a three-dimensional space around the set of sensors and a point cloud representation of the three-dimensional space; form a fused bird's eye view (BEV) representation of the three-dimensional space from the one or more images and the point cloud representation; generate Gaussian primitives using the fused BEV representation, the Gaussian primitives representing objects in the three-dimensional space; and project the Gaussian primitives into the BEV representation using Gaussian splatting to form an enhanced BEV representation of the three-dimensional space.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example vehicle including an autonomous driving controller according to techniques of this disclosure.

FIG. 2 is a block diagram illustrating an example set of components of an autonomous driving controller according to techniques of this disclosure.

FIG. 3 is a block diagram illustrating an example set of components that may be included in a bird's eye view (BEV) determination unit according to techniques of this disclosure.

FIG. 4 is a block diagram illustrating an example vehicle with a multi-camera system and an autonomous driving controller according to techniques of this disclosure.

FIG. 5 is a flowchart illustrating an example method of training a neural network according to techniques of this disclosure.

### DETAILED DESCRIPTION

Depth estimation is an important component of autonomous driving (AD), autonomous driving assistance systems (ADAS), or other systems used to partially or fully autonomously control a vehicle or other device, e.g., for robot navigation. Depth estimation may also be used for extended reality (XR) related tasks, such as augmented reality (AR), mixed reality (MR), or virtual reality (VR). Depth information is important for accurate 3D detection and scene representation. Depth estimation for such techniques may be used for autonomous driving, assistive robotics, augmented reality/virtual reality scene composition, image editing, or other such techniques. Other types of image processing can also be used for AD/ADAS or other such systems, such as semantic segmentation, object detection, or the like. Autonomous vehicles may use various sensors such as light detection and ranging (LIDAR) units, RADAR units, and/or one or more cameras (e.g., monocular cameras, stereo cameras, or multi-camera arrays, which may face different directions).

Three-dimensional object detection (3DOD) may include generating a bird's eye view (BEV) representation of a three-dimensional space. That is, while cameras may capture images to the sides of a moving object, such as a vehicle, and a LIDAR unit may capture a point cloud representation, the camera and LIDAR data may be used to generate a bird's eye view perspective, i.e., a top-down perspective. Downstream tasks, such as object tracking and prediction, may benefit from a BEV representation. Creating an accurate BEV representation from multi-sensor data, such as cameras and LIDAR, is often important for perception-based tasks, such as object detection, tracking, and motion forecasting.

This disclosure recognizes that certain key challenges arise when fusing camera and LIDAR data into BEV space. In some cases, there may be missing views and incomplete data. For example, camera and LIDAR sensors often provide only partial datasets, due to occlusions, sensor range limitations, and varying perspectives. Certain conventional techniques, such as the lift-splat-shoot (LSS) method, commonly used to lift camera features into BEV space, may be susceptible to inaccuracies when generating depth information, especially in occluded or distant regions. The conventional BEV fusion process may further be complicated due to missing views, e.g., resulting from sensor dropout or obstruction, leading to incomplete BEV reconstruction. This gap may significantly reduce the reliability of the 3D scene understanding, which can cause issues in safety-critical conditions.

Additionally, there may be uncertainty and noise in fusion of sensor inputs in the BEV space. The fusion of camera and LIDAR data may inherently introduce uncertainty, especially due to noise in the LIDAR point cloud and errors in the depth estimation from cameras. These uncertainties may be particularly problematic in regions where LIDAR point density is low or where camera images struggle with motion blur or poor lighting conditions. Conventional fusion techniques struggle to properly capture and model the uncertainty in BEV space, often leading to overconfident predictions or unreliable estimations in noisy regions.

Diffusion models are generally effective in generating high-quality data through an iterative refinement process for missing views. However, diffusion models can face certain drawbacks in this context. One of the notable drawbacks of diffusion models is the multi-step, iterative process for generating high-quality outputs. Each inference requires numerous steps (typically hundreds to thousands) to refine the generated data from noise to a coherent 3D scene. This leads to longer inference times, making real-time applications like autonomous driving or AR/VR impractical. Diffusion models, while powerful in generating novel data, are not inherently designed to handle uncertainty in the input data. Diffusion models are generally configured to focus on refining a data distribution over many steps, but do not provide a natural mechanism for capturing and propagating spatial uncertainty from input features.

Neural Radiance Fields (NeRF) have shown promise in reconstructing detailed 3D scenes by learning volumetric representations from 2D images. However, in the context of BEV space and sensor fusion, NeRF also faces certain notable limitations. NeRF is computationally expensive and relies on dense input data to reconstruct accurate scenes. This makes it difficult to handle sparse LIDAR data or areas with missing information in real-time on a mobile device. NeRF models generally rely heavily on dense, high-quality input data from multiple views. When LIDAR data is sparse or noisy, NeRF struggles to interpolate gaps in the data effectively, resulting in poor quality reconstructions. This limitation becomes more evident in environments where LIDAR captures sparse depth information, like outdoor scenes with distant objects. Due to the need for dense volumetric representations, NeRF models consume significant memory during both training and inference. This presents scalability challenges, particularly for larger scenes or complex environments, limiting their practicality for edge deployment or mobile applications but also enhances efficiency and robustness to noise. NeRF works best for localized scene reconstructions and has limitations in scalability when dealing with large outdoor environments, such as those encountered in autonomous driving.

Both Diffusion models and NeRF show promise for generating and reconstructing 3D data, but are not well-suited to addressing the key challenges of missing views, noise, and uncertainty in BEV fusion. The inability of these methods to handle real-time inference and their reliance on dense, high-quality data make them unsuitable for critical applications such as autonomous driving, where real-time, reliable predictions with uncertainty estimation are needed.

This disclosure describes techniques that use Gaussian primitives in BEV fusion. In particular, Gaussian primitives may be calculated based on sensor input, such as from features extracted from image and point cloud data. The features may be fused to form an initial BEV representation. The Gaussian primitives may then be combined with the initial BEV representation to form an enhanced BEV representation. The use of Gaussian primitives may address uncertainty and missing data while maintaining computational efficiency. Gaussian splatting is a process of projecting Gaussian primitives onto a 2D or into a 3D space (such as a 2D or 3D BEV space) by “splatting” their probabilistic distributions, enabling smooth, continuous scene representation and interpolation across sparse or missing data regions.

The techniques of this disclosure include introduction of Gaussian primitives into the BEV fusion pipeline, which may offer a robust solution to the challenges of missing views, uncertainty, and noise in camera-LIDAR fusion. The use of Gaussian primitives per the techniques of this disclosure may provide a more effective approach than conventional techniques.

In general, generating a BEV representation from fusion of features based on sensor input is hindered by uncertainty that arises from the sensor input (e.g., image data and LIDAR data) due to sensor noise, occlusions, or incomplete views. Gaussian primitives, which correspond to features representative of objects in a three-dimensional space, naturally capture the uncertainty by explicitly modeling spatial variance. Each Gaussian primitive may be parameterized by a mean value and a covariance, such as a covariance matrix. The mean value (U) represents a central position of an object or feature in the BEV space. The covariance, e.g., covariance matrix, acts as a direct representation of the uncertainty or spread around the mean. This covariance (matrix) allows for a continuous, probabilistic representation of objects and scene elements in the BEV space, which allows a BEV generation system to handle noisy or incomplete sensor data more gracefully. Unlike deterministic representations that assume perfect accuracy, Gaussian primitives can handle uncertain depth estimates from camera sensors and sparse LIDAR point clouds by quantifying the confidence in the detected features.

Gaussian primitives offer a smooth, continuous representation of objects and features in the BEV space. This contrasts with the discrete point-based representations often used in LIDAR systems or the grid-based features from camera images. The Gaussian representation may offer a variety of benefits. Use of Gaussian primitives may interpolate missing data. When certain regions in the BEV space have missing sensor data (e.g., due to occlusions or sensor limitations), Gaussian primitives can smooth over these regions, providing estimates based on the spread of surrounding data. This may help to fill gaps caused by missing views in both camera and LIDAR inputs. Additionally, the Gaussian primitives may handle noisy data. Gaussian primitives are naturally suited for handling noisy data by representing uncertainty as a spread around the mean, thus preventing overconfident predictions in uncertain regions.

Gaussian primitives can provide a compact way to represent spatial information, reducing the overall complexity of the model. Instead of maintaining dense feature maps or point clouds that require substantial computation, Gaussian primitives reduce the burden by representing features probabilistically through a small set of parameters (mean and covariance). The compact nature of Gaussian primitives may improve the computational efficiency of the BEV fusion process, which is crucial for real-time applications in, e.g., autonomous driving. Gaussian primitives can represent complex, large-scale environments without the need for dense input data. This may offer a significant advantage over techniques like NeRF, which require dense data for accurate reconstruction and struggle with scalability.

Gaussian primitives can act as guiding anchors during the fusion of camera and LiDAR features. By representing the spatial uncertainty and position of objects or scene elements probabilistically, Gaussian primitives can enhance attention mechanisms that align and merge camera and LIDAR data, and/or other multi-sensor input data. Gaussian primitives may encode depth and shape information, which can improve the precision of object boundaries and depths in the fused BEV representation. In regions with missing or incomplete views, Gaussian primitives can act as a prior for object localization, guiding the fusion process to make more informed decisions based on uncertainty-aware representations.

Diffusion models and NeRF have several limitations when applied to BEV fusion. Diffusion models require multiple iterations during inference, which makes them computationally expensive and slow, and they are not well-suited for capturing uncertainty in sensor data. NeRF struggles with noisy or sparse data and has high computational costs, limiting its scalability to large outdoor environments or real-time applications. By contrast, Gaussian primitives offer real-time inference and robustness to noisy data. Gaussian primitives are computationally efficient to predict and can be integrated into real-time systems. The probabilistic nature of Gaussian primitives allows them to handle sparse and noisy sensor inputs more effectively than NeRF or diffusion models, making them a better fit for BEV fusion in dynamic environments.

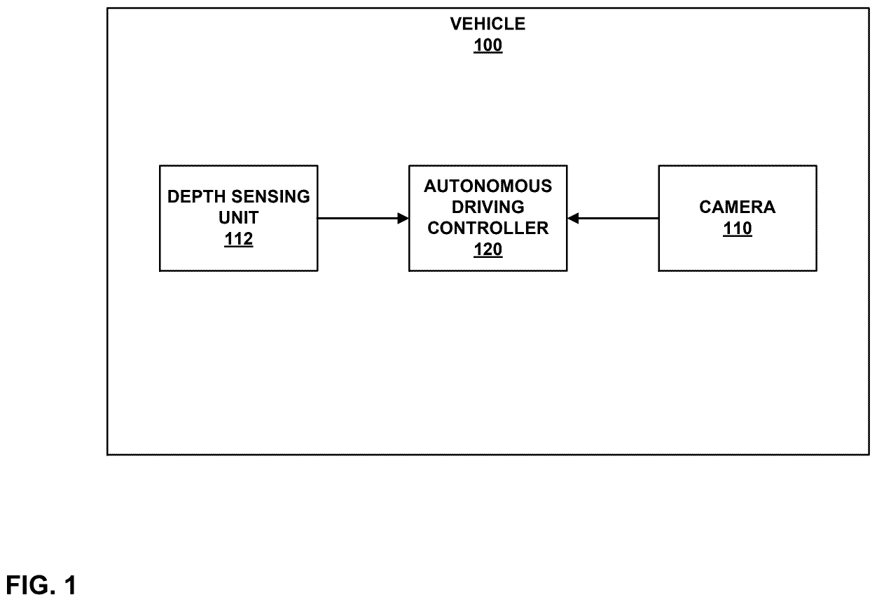

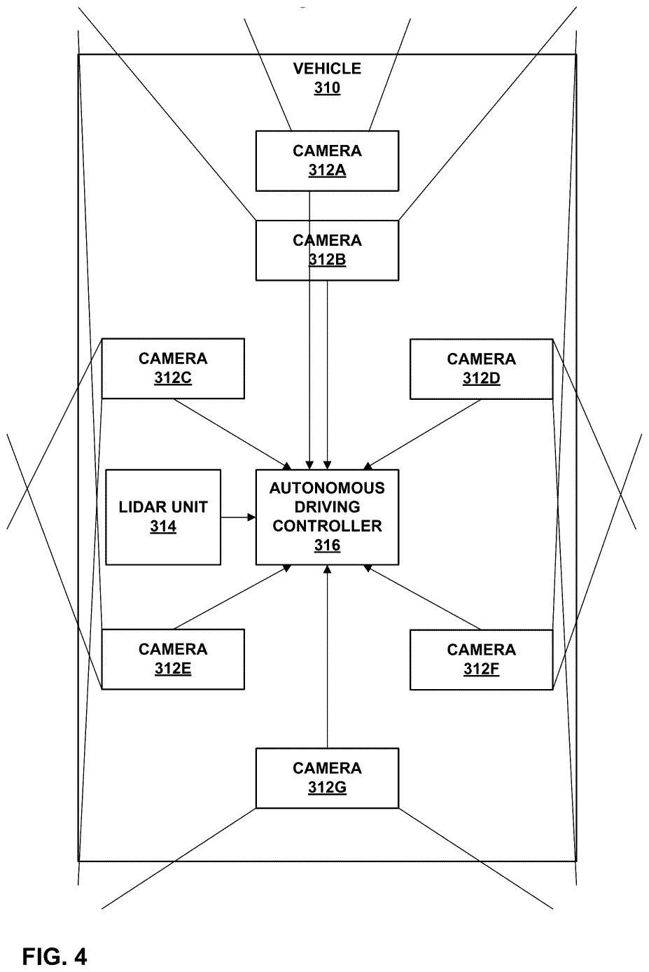

FIG. 1 is a block diagram illustrating an example vehicle 100 including an autonomous driving controller 120 according to techniques of this disclosure. In this example, vehicle 100 includes camera 110, depth sensing unit 112, and autonomous driving controller 120. Camera 110 is a single camera in this example. While only a single camera is shown in the example of FIG. 1, in other examples, multiple cameras may be used. However, the techniques of this disclosure allow for depth to be calculated for objects in images captured by camera 110 without additional cameras. In some examples, multiple cameras may be employed that face different directions, e.g., front, back, and to each side of vehicle 100, e.g., as shown in FIG. 4. Autonomous driving controller 120 may be configured to calculate depth for objects captured by each of such cameras.

Depth sensing unit 112 may include any or all of a light detection and ranging (LIDAR) unit, a radio detection and ranging (RADAR) unit, a depth from stereo unit, and/or other devices that calculate depth values for objects in a real-world environment. Depth sensing unit 112 provides point cloud data (e.g., LIDAR data) for vehicle 100 to autonomous driving controller 120. Depth sensing unit 112 may, for example, determine a point cloud for a three-dimensional area, where camera 110 also captures an image of the area. In the case of LIDAR, for example, the point cloud may generally include points corresponding to surfaces or objects in the area identified by a light (e.g., laser) emitted by depth sensing unit 112 depth sensing unit 112 and reflected back to depth sensing unit 112. Based on the angle of emission of the light from depth sensing unit 112 and time taken for the light to traverse from depth sensing unit 112 to the object and back, depth sensing unit 112 can determine a three-dimensional coordinate for the point.

Autonomous driving controller 120 receives image frames captured by camera 110, e.g., at a high frame rate, such as 30 fps, 60 fps, 90 fps, 120 fps, or even higher. Autonomous driving controller 120 also receives point cloud data captured by depth sensing unit 112, e.g., at a corresponding rate, such that a point cloud is paired with the image frame (or frames of a multi-camera system). Autonomous driving controller 120 may include an (artificial) neural network trained according to the techniques of this disclosure to generate a depth map using fused features extracted from the frame(s) and the point cloud.

According to the techniques of this disclosure, autonomous driving controller 120 may receive a point cloud or other such data structure from depth sensing unit 112 and image data from camera 110 (at a given time). Autonomous driving controller 120 may extract features from the point cloud (which may also be considered a type of range data) and camera image data, form respective projections using the extracted features, and fuse the projections to form an initial BEV representation. Autonomous driving controller 120 may then generate Gaussian primitives from point cloud data 152 and image data 150 and merge the initial BEV representation with the Gaussian primitives, e.g., using Gaussian splatting, to form an enhanced BEV representation.

The use of Gaussian primitives introduces a probabilistic representation of spatial features in the BEV space, explicitly modeling uncertainty with a covariance (matrix) for each feature. This may enhance robustness to noise, occlusion, and missing data, improving the reliability of object detection and scene understanding. Unlike static representations, the Gaussian primitives can dynamically deform based on local scene complexity. For uncertain regions (e.g., occlusions or motion), the covariance elongates to capture uncertainty, while in stable regions, the covariance contracts for finer detail. This adaptive modeling offers a context-sensitive approach to uncertainty.

Gaussian primitives may provide a smooth and continuous interpolation of sparse or incomplete sensor data (especially LIDAR data). This may mitigate the limitations of fusion methods that struggle with sensor dropouts or sparse input data, enhancing the completeness of BEV reconstructions. The integration of Gaussian priors into the self-attention mechanism can improve feature selection during the decoding process. By modulating the contribution of uncertain regions, the network's attention is more focused on reliable features, leading to better object localization and prediction accuracy.

Gaussian primitives offer a compact yet expressive representation of spatial features, reducing the overall computational load of computing a BEV representation. This makes the system more scalable for large outdoor environments and suitable for real-time applications like autonomous driving, where both speed and accuracy are crucial. By combining the original BEV features with Gaussian primitives, the final, enhanced BEV feature map may achieve better interpolation of missing data and more accurate spatial distributions, leading to improved performance in downstream tasks like tracking, motion forecasting, and object detection. In this manner, the techniques of this disclosure may address challenges of missing views, uncertainty, and noise while remaining computationally efficient for real-time applications.

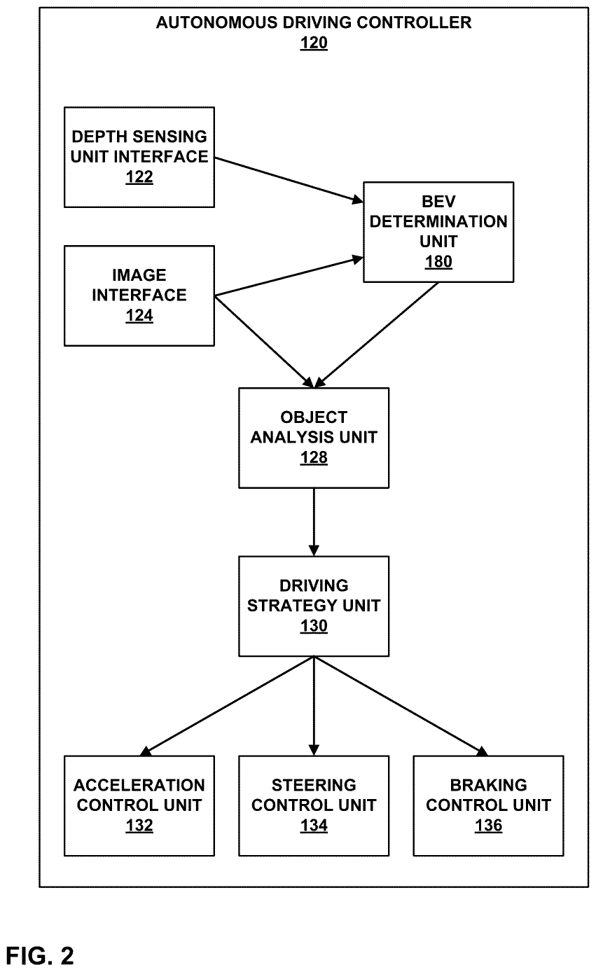

FIG. 2 is a block diagram illustrating an example set of components of autonomous driving controller 120 of FIG. 1 according to techniques of this disclosure. In this example, autonomous driving controller 120 includes depth sensing unit interface 122, image interface 124, bird's eye view (BEV) determination unit 180, object analysis unit 128, driving strategy unit 130, acceleration control unit 132, steering control unit 134, and braking control unit 136.

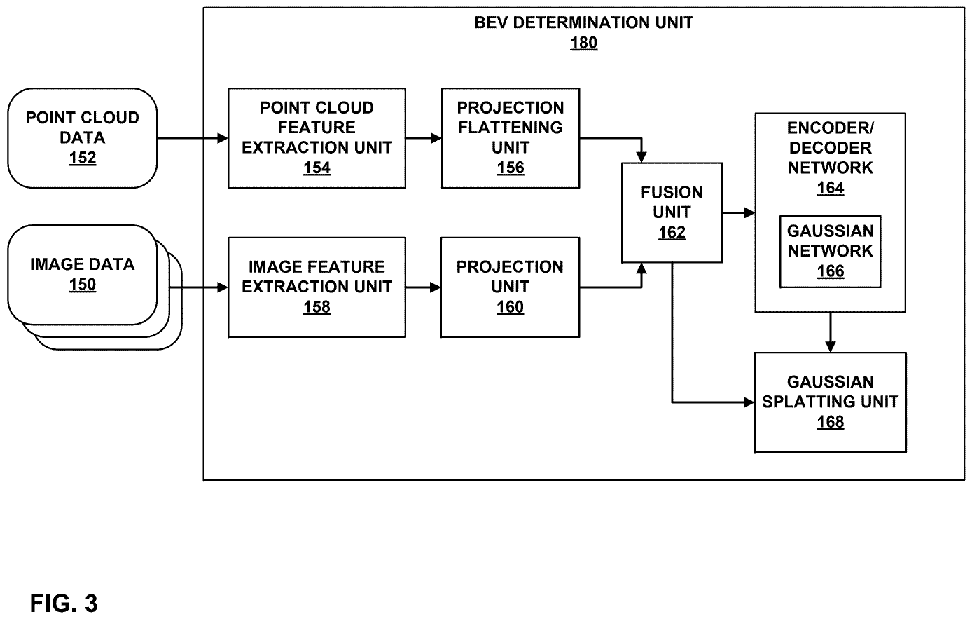

In general, depth sensing unit interface 122 represents an interface to depth sensing unit 112 of FIG. 1, which receives point cloud data (e.g., LIDAR data) from depth sensing unit 112 and provides the LIDAR/point cloud data to BEV determination unit 180. In particular, as described in greater detail below with respect to FIG. 3, BEV determination unit 180 may determine a BEV representation from images received via image interface 124 and a point cloud received via depth sensing unit interface 122. Per the techniques of this disclosure, BEV determination unit 180 may extract features from the images and the point cloud, form projection representations using the features, then merge the projections to form a fused initial BEV representation. Furthermore, BEV determination unit 180 may generate Gaussian primitives from the image and point cloud (e.g., LIDAR) features, then combine the initial BEV representation with the Gaussian primitives, e.g., using Gaussian splatting.

Image interface 124 may also provide the image frames to object analysis unit 128. Likewise, BEV determination unit 180 may provide depth values for objects in the images to object analysis unit 128. Object analysis unit 128 may generally determine where objects are relative to the position of vehicle 100 at a given time, and may also determine whether the objects are stationary or moving. Object analysis unit 128 may provide object data to driving strategy unit 130, which may determine a driving strategy based on the object data. For example, driving strategy unit 130 may determine whether to accelerate, brake, and/or turn vehicle 100. Driving strategy unit 130 may execute the determined strategy by delivering vehicle control signals to various driving systems (acceleration, braking, and/or steering) via acceleration control unit 132, steering control unit 134, and braking control unit 136.

The various components of autonomous driving controller 120 may be implemented as any of a variety of suitable circuitry components, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure.

FIG. 3 is a block diagram illustrating an example set of components that may be included in BEV determination unit 180 of FIG. 2. In this example, BEV determination unit 180 includes point cloud feature extraction unit 154, projection flattening unit 156, image feature extraction unit 158, projection unit 160, fusion unit 162, encoder/decoder network 164, Gaussian network 166, and Gaussian splatting unit 168. Multi-modal inputs, such as image and point cloud/LIDAR inputs, may help to make more accurate predictions of depth maps, reduce reliance on a single sensor, and also address common issues such as sensor occlusion, e.g., if an object is obstructing one or more cameras and/or the LIDAR unit at a given time.

In this example, BEV determination unit 180 receives one or more images in the form of image data (e.g., from one or more cameras, such as cameras in front, to the sides of, and/or to the rear of vehicle 100 of FIG. 1), and point cloud data 152. Point cloud feature extraction unit 154 extracts 3D sparse features from the point cloud data, such as occupancy information or local geometric descriptors. Point cloud feature extraction unit 154 provides the 3D sparse features to projection flattening unit 156. Similarly, image feature extraction unit 158 extracts perspective view features from the one or more images and provides the perspective view features to projection unit 160. Projection flattening unit 156 forms a flattened projection from the 3D sparse features (into BEV space), and projection unit 160 converts the image features from a perspective view to BEV projection.

The flattened projection and the BEV projection share a BEV space, in which fusion unit 162 can perform fusion for better spatial representation. Thus, fusion unit 162 receives the projections and fuses the projections to form an initial BEV representation.

Fusion unit 162 provides the initial BEV representation to encoder/decoder network 164. Encoder/decoder network 164 includes both an encoder and a decoder. Encoder/decoder network 164 also generates Gaussian primitives according to techniques of this disclosure. In particular, encoder/decoder network 164 includes Gaussian network 166 that receives both the image features and the 3D sparse features as inputs and predicts the Gaussian primitives to represent 3D objects and scene elements in the environment. The Gaussian primitives are each continuous, probabilistic representations of corresponding spatial features. Each Gaussian primitive is parameterized by two elements. A Gaussian primitive G in BEV space may generally be represented by a mean μ and covariance matrix Σ, which describe the location and spread (or uncertainty) of a feature in the BEV map. This is modeled as a 2D Gaussian distribution according to:

$$G ( x ) = exp ( - \frac{1}{2} {( x - μ )}^{T} {\sum }^{- 1} ( x - μ ) )$$

In this example, x is in R³, representing a point in the BEV space; μ is in R², representing the mean (or the center) of the Gaussian primitive; and 2 is in R^{2×2} representing the covariance matrix, which encodes the shape and spread (or uncertainty) of the feature. Simplified representations may equally be used, such as a diagonal covariance matrix (as detailed below) or even a scalar covariance for an isotropic covariance. While it is generally referred here and in the following to a covariance matrix, the present disclosure equally comprises implementations of a diagonal covariance matrix and a scalar covariance.

To predict the parameters of the Gaussian primitives, Gaussian network 166 uses the fused BEV features as input, and outputs, for each feature of the initial BEV representation (also referred to as a BEV map or “F_{BEV}”), the mean value representing the location of the feature and the covariance (matrix) describing the uncertainty or spread of the feature around its mean, allowing for the representation of variance in the x and y axes in the BEV space.

Gaussian network 166 may be structured as an encoder/decoder network, designed to predict the parameters u and 2 (mean and covariance) for Gaussian primitives from fused camera and LiDAR features. Gaussian network 166 predicts the Gaussian parameters by passing the fused BEV features through an encoder-decoder architecture:

$$\begin{matrix}μ = {Decoder}_{μ} ( {F}_{BEV} ) \\ \sum = {Decoder}_{\sum } ( {F}_{BEV} )\end{matrix}$$

The encoder of encoder/decoder network 164 processes the input features (camera features, LIDAR features, and/or the fusion of the camera features and the LIDAR features) and extracts higher-level feature maps. These feature maps may contain spatial and semantic information for predicting the Gaussian primitives. Let the input BEV features be F_{BEV} derived from the fusion of camera and LIDAR BEV features. That is, F_{BEV} can be represented as:

$${F}_{BEV} = Fusion ( {F}_{cam - BEV} , {F}_{lidar - BEV} )$$

The encoder can include several convolutional layers, which progressively downsample the input BEV feature map while capturing increasingly abstract spatial information (e.g., in the form of geometric primitives, such as polygons). The encoded feature map F_{encoded} is:

$${F}_{encoded} = Encoder ( {F}_{BEV} )$$

The decoder of encoder/decoder network 164 predicts the Gaussian parameters mean and covariance (matrix) from the encoded features. The decoder may follow an upsampling process, where the encoded feature map is gradually restored to the original resolution of the BEV space while predicting the Gaussian parameters.

The decoder may output a 2D mean μ=(μₓ, μ_{y}) for each feature in the BEV space, representing the central location of each predicted Gaussian primitive. The mean may be predicted through a convolutional layer that maps the encoded feature map to a 2D output:

$$μ = {Decoder}_{μ} ( {F}_{encoded} )$$

Each point in the output map corresponds to the mean of a Gaussian primitive in BEV space.

The covariance matrix Σ represents the uncertainty and orientation of the Gaussian primitive. For simplicity, the covariance matrix may be assumed to be diagonal, meaning there is no correlation between the x and y directions. Therefore, Gaussian network 166 may predict two variance values

$${σ}_{x}^{2} and {σ}_{y}^{2} ,$$

which define the uncertainty along the x and y axes, respectively:

$$\sum = diag ( {σ}_{x}^{2} , {σ}_{y}^{2} )$$

In the simplest case, an isotropic covariance may be assumed where the two variance values

$${σ}_{x}^{2} and {σ}_{y}^{2}$$

are the same. This assumption may further reduce the computational complexity.

The covariance prediction may also be handled through a convolutional layer, which outputs the values

$${σ}_{x}^{2} and {σ}_{y}^{2}$$

(or an isotropic covariance σ²) for each Gaussian primitive:

$$\sum = {Decoder}_{\sum } ( {F}_{encoded} )$$

The final output from the decoder is a set of Gaussian primitives, each defined by their respective parameters μ and Σ:

$$μ = ( {μ}_{x} , {μ}_{y} )$$

The mean (center) of the primitive.

$$\sum = diag ( {σ}_{x}^{2} , {σ}_{y}^{2} )$$

The covariance matrix (diagonal for simplicity), defining the uncertainty along the x and y directions.

The collection/set of Gaussian primitives forms a probabilistic map that describes the spatial distribution of features in BEV space, including their uncertainties. In the simplified case where the covariance matrix is diagonal

$$\sum = diag ( {σ}_{x}^{2} , {σ}_{y}^{2} ) ,$$

the Gaussian primitive simplifies to:

$$G ( x ; μ , \sum ) = exp ( - \frac{1}{2} ( \frac{{( x - {μ}_{x} )}^{2}}{{σ}_{x}^{2}} + \frac{{( y - {μ}_{y} )}^{2}}{{σ}_{y}^{2}} ) )$$

This formulation describes how the uncertainty of a feature spreads around its mean μ in BEV space, with the spread determined by the variances

$${σ}_{x}^{2} and {σ}_{y}^{2} .$$

Instead of (spatially and temporally) fixed covariance matrices, Gaussian network 166 may adapt Gaussian primitives, e.g., dynamically based on local scene complexity.

According to one aspect, Gaussian network 166 may adapt Gaussian primitives spatially by adapting (or varying) their covariances according to a region of the BEV space where the corresponding feature is located. The Gaussian primitives (specifically, their covariances) may be adapted according to a level of uncertainty associated with the region. For regions with higher uncertainty (e.g., occlusions, rapid motion, and/or low or no coverage by one or more of the camera or LIDAR sensors), the covariance can elongate or deform to better capture spatial uncertainty, while in more stable regions (within range of both, camera and LIDAR sensors, with no or slow motion, etc.), it can contract to provide finer detail. This context-sensitive deformation may enhance both feature localization and uncertainty modeling.

Based on the ego-motion of the vehicle, a spatial adaptation may translate into a temporal adaptation. Additionally, or alternatively, Gaussian network 166 may adapt (the covariances of) the Gaussian primitives based on contextual data which may characterize one or more conditions generally affecting the uncertainty of extracted features (possibly across the entire BEV space). Exemplary contextual data may include a linear and/or angular speed of the ego-motion of the vehicle, ambient light conditions, a type (urban, rural, etc.) of environment where the vehicle is located, weather conditions (such as rain, snow, fog, etc.), and/or the like. Contextual data may be provided by one or more respective sensors, such as speed and/or angular sensors, an ambient light sensor, a GPS sensor, a map data unit (for a navigation system) and/or the like.

Additionally, or alternatively, Gaussian network 166 may adapt (the covariances of) the Gaussian primitives based on sensor-related data, e.g., based on sensor characteristics of the employed image and/or LIDAR sensors, such as range, spatial and/or temporal resolution, and/or precision or reliability of captured data.

Additionally, or alternatively, Gaussian network 166 may adapt (the covariances of) the Gaussian primitives dynamically based on characteristics of the input BEV feature map. By way of example, covariances may be increased compared to a reference value for occluded regions and/or regions with a spatial density of features below a threshold density. Covariances may be decreased compared to a reference value for regions with a spatial density of features larger than or equal to a threshold density.

Overall, Gaussian network 166 may adapt (the covariances of) the Gaussian primitives based on one or more characteristics characterizing a level of uncertainty of one or more features of the input BEV feature map with regard to one or more of a context of the feature, an occlusion of the feature, a sensor characteristic, or a location of the feature in the input BEV feature map.

After Gaussian network 166 predicts the Gaussian primitives, Gaussian network 166 may incorporate the Gaussian primitives into the fused BEV feature map. To this end, Gaussian network 166 may provide the Gaussian primitives to Gaussian splatting unit 168, while fusion unit 162 may provide the initial BEV representation (F_{BEV}) to Gaussian splatting unit 168. Gaussian network 166 (and/or Gaussian splatting unit 168) may add the Gaussian primitives to the existing fused features to enhance the spatial representation. Gaussian network 166 (and/or Gaussian splatting unit 168) may form the final enhanced BEV feature map (F_{final-BEV}) by combining the original fused BEV feature map (F_{BEV}) with the Gaussian primitives, e.g.:

$${F}_{final - DEV} = {F}_{BEV} + G ( x ; μ , \sum )$$

where G(x; μ, Σ) represents the Gaussian primitive at each point in the BEV space. The enhanced BEV feature map incorporates the probabilistic information from the Gaussian primitives, improving the system's robustness to noisy sensor data and enabling better interpolation of missing data.

Using Gaussian parameters in this manner may improve the generation of the BEV representation. For example, the covariance matrix encodes the uncertainty of each feature in the BEV space, making BEV determination unit 180 more robust to noisy data and occlusions. The Gaussian primitives provide a continuous and smooth representation of spatial features, which may help to interpolate missing information, especially in cases where sensor data is sparse or incomplete. The Gaussian primitives may also offer a compact way of encoding spatial information, which is beneficial for large-scale BEV maps, thereby reducing the computational load. By combining the fused BEV features with Gaussian primitives, BEV determination unit gains a probabilistic understanding of the environment, thereby improving the accuracy of downstream tasks, such as object detection, tracking, and motion prediction.

Along with incorporating Gaussian priors in the BEV feature map (as described above), the Gaussian priors may be incorporated into one or more self-attention blocks in the decoder of encoder/decoder network 164. Gaussian primitives may adapt dynamically based on local scene complexity (as described above). For regions of the BEV space with higher uncertainty (e.g., occlusions or rapid motion), the covariance can elongate or deform to better capture spatial uncertainty, while in more stable regions, the covariance can contract to provide finer detail. This context-sensitive deformation may enhance both feature localization and uncertainty modeling. Encoder/decoder network 164 may use this prior information derived by Gaussian primitives as context in the self-attention layers of the decoder.

Self-attention can be masked based on uncertainty. In areas where the network is uncertain of its prediction (based on corresponding Gaussian primitives), Gaussian network 166 may decrease the overall contribution of the Gaussian primitives to the self-attention block. Hence, to compute a binary mask G_{hard} on the Gaussian primitive G(x; μ, Σ), given threshold t:

$${G}_{hard} = \{ \begin{matrix}0 , & G ( x ; μ , \sum ) > t \\ - ∞ , & otherwise\end{matrix}$$

Next, in the self-attention operation, Gaussian network 166 may use the masked attention to modulate features Fₓ such that:

$${F}_{x - modulated} = {F}_{x} + softmax ( {G}_{hard} + Q ( {F}_{K} ) {K ( {F}_{K} )}^{T} ) V ( Fx )$$

where Q, K, and V are linear projections representing the query, keys, and values of Fₓ. Masking self-attention in areas of uncertain prediction (i.e., where the corresponding Gaussian primitive evaluates to values smaller than or equal to the threshold t) may reduce computational complexity by effectively reducing the support of the Gaussian primitive.

FIG. 4 is a block diagram illustrating an example vehicle 310 with a multi-camera system and autonomous driving controller 316 according to techniques of this disclosure. In particular, vehicle 310 includes cameras 312A-312G, and LIDAR unit 314. In this example, cameras 312A and 312B are front-facing cameras with different focal lengths, cameras 312C and 312D are side-rear facing cameras, cameras 312E and 312F are side-front facing cameras, and camera 312G is a rear-facing camera. In this manner, imagery can be captured by the collection/set of cameras 312A-312G for a 360 degree view around vehicle 310.

LIDAR unit 314 may generate LIDAR/point cloud data around vehicle 310 in 360 degrees. Thus, LIDAR/point cloud data may be generated for images captured by each of cameras 312A-312G. Both images and LIDAR data may be provided to autonomous driving controller 316.

Autonomous driving controller 316 may include components similar to those of autonomous driving controller 120 of FIG. 2. For example, autonomous driving controller 316 may include a BEV determination unit that performs the techniques of this disclosure, as discussed above, to extract features from the images and LIDAR data, fuse the extracted features, then generate a depth map from the fused features. In particular, autonomous driving controller 316 may track features extracted from images and LIDAR data over time, e.g., from consecutive frames, according to the techniques of this disclosure, to generate a BEV representation of a real-world space around vehicle 310. Autonomous driving controller 316 may then use the BEV representation when making autonomous driving decisions to control vehicle 310.

In particular, when generating the BEV representation, per the techniques of this disclosure, autonomous driving controller 316 may extract features from image data and LIDAR data, fuse the features extracted from the image data and the LIDAR data, and provide the fused features to a Gaussian network. The Gaussian network may predict Gaussian primitives for the features, and then combine the Gaussian primitives with the fused features to form an enhanced, final BEV representation. Autonomous driving controller 316 may then use the enhanced, final BEV representation to at least partially control vehicle 310.

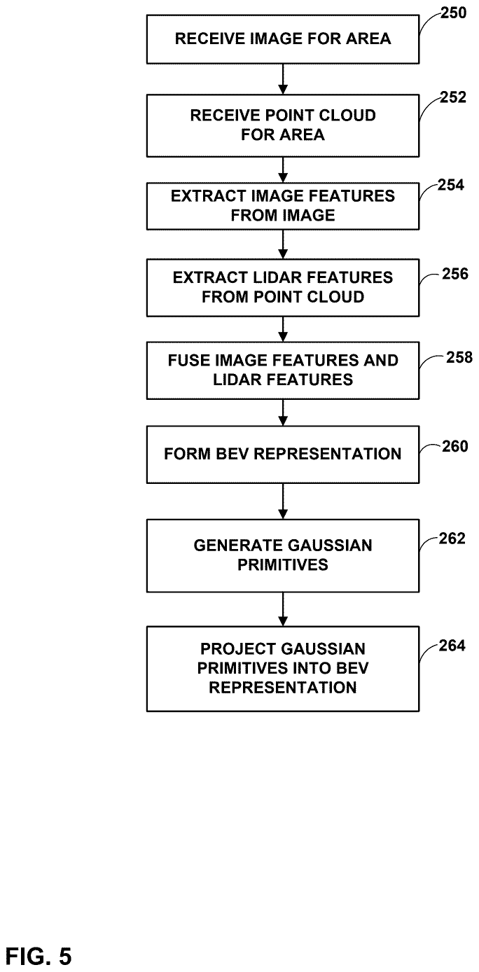

FIG. 5 is a flowchart illustrating an example method of constructing a bird's eye view (BEV) representation of a real-world space according to techniques of this disclosure. The method of FIG. 5 is described with respect to BEV determination unit 180 of FIG. 3 for purposes of explanation. However, other units or devices may be configured to perform this or a similar method.

Initially, BEV determination unit 180 receives an image for an area (250), e.g., an area around or near vehicle 100 (FIG. 1). BEV determination unit 180 also receives a point could cloud for the area (252), which may correspond to a point cloud generated by a LIDAR unit. The method of FIG. 5 represents the techniques of this disclosure as performed for a current time t. When performing these techniques, image and point cloud data may also be collected for a previous frame at time t−1 and/or a next frame at time t+1, as discussed above. BEV determination unit 180 may thus update the enhanced BEV representation over time using updated images collected at a future time t+n, updated point cloud data collected at future time t+n, and updated Gaussian primitives calculated using the updated images and point cloud data. BEV determination unit 180 may extract image features from the image (254) and extract LIDAR features from the point cloud (256).

BEV determination unit 180 may then, as discussed above, fuse the image features with the LIDAR features (258). BEV determination unit 180 may also form an initial BEV representation using the fused image features and LIDAR features (260). An encoder/decoder network may then generate Gaussian primitives as discussed above for one or more of the features in the initial BEV representation (262). According to one aspect, the encoder/decoder network may generate Gaussian primitives as discussed above for each of the features in the initial BEV representation (262). BEV determination unit 180 may then combine the Gaussian primitives with the initial BEV representation to form an enhanced BEV representation (264). According to an aspect, BEV determination unit 180 may project the Gaussian primitives into the initial BEV representation using Gaussian splatting, forming the enhanced BEV representation (264).

In this manner, the method of FIG. 5 represents an example of a method of processing media data, including: receiving sensor input from a set of sensors, the sensor input including one or more images of a three-dimensional space around the set of sensors and a point cloud representation of the three-dimensional space; forming a fused bird's eye view (BEV) representation of the three-dimensional space from the one or more images and the point cloud representation; generating Gaussian primitives using the fused BEV representation, the Gaussian primitives representing objects in the three-dimensional space; and projecting the Gaussian primitives into the BEV representation using Gaussian splatting to form an enhanced BEV representation of the three-dimensional space.

Various examples of the techniques of this disclosure are summarized in the following clauses:

Clause 1: A method of processing media data, the method comprising: receiving sensor input from a set of sensors, the sensor input including one or more images of a three-dimensional space around the set of sensors and a point cloud representation of the three-dimensional space; forming a fused bird's eye view (BEV) representation of the three-dimensional space from the one or more images and the point cloud representation; generating Gaussian primitives using the fused BEV representation, the Gaussian primitives representing objects in the three-dimensional space; and projecting the Gaussian primitives into the BEV representation using Gaussian splatting to form an enhanced BEV representation of the three-dimensional space.

Clause 2: The method of clause 1, wherein generating the Gaussian primitives comprises, for each of the Gaussian primitives, calculating a mean value and a covariance matrix.

Clause 3: The method of clause 2, wherein forming the fused BEV representation comprises performing feature extraction using the sensor input to extract features representing positions of objects in the three-dimensional space, and wherein generating the Gaussian primitives comprises, for each of the features, calculating the mean value as a central position of the feature and the covariance matrix as a representation of uncertainty around the mean value.

Clause 4: The method of clause 2, wherein generating the Gaussian primitives comprises, for each region of a set of regions of the three-dimensional space: determining a local complexity of the region; determining a subset of the features in the region; and for each of the subset of the features in the region, deforming the covariance matrix for the feature according to the local complexity of the region.

Clause 5: The method of clause 1, wherein generating the Gaussian primitives comprises: determining input features from at least one of the sensor input or the fused BEV representation; extracting high-level feature maps from the input features; progressively downsampling the high-level feature maps to form a set of downsampled feature maps; encoding the set of downsampled feature maps to form an encoded feature map including encoded features of the objects in the three-dimensional space; and decoding the encoded feature map, including progressively upsampling the encoded feature map to an original resolution of the three-dimensional space and, during the decoding, predicting the Gaussian primitives.

Clause 6: The method of clause 5, wherein decoding the encoded feature map comprises decoding, by one or more self-attention layers of a decoder, the method further comprising using previously determined Gaussian primitives as context in the self-attention layers of the decoder.

Clause 7: The method of clause 6, further comprising: calculating a binary mask from the Gaussian primitives based on a threshold for the Gaussian primitives; and modulating, by the self-attention layers, the input features using the binary mask.

Clause 8: The method of clause 1, further comprising at least partially autonomously controlling a vehicle using the enhanced BEV representation.

Clause 9: The method of clause 1, further comprising updating the enhanced BEV representation over time based on updated sensor input from the set of sensors and updated Gaussian primitives from the updated sensor input.

Clause 10: A device for processing media data, the device comprising: a memory for storing media data; and a processing system comprising one or more processors implemented in circuitry, the processing system being configured to: receive sensor input from a set of sensors, the sensor input including one or more images of a three-dimensional space around the set of sensors and a point cloud representation of the three-dimensional space; form a fused bird's eye view (BEV) representation of the three-dimensional space from the one or more images and the point cloud representation; generate Gaussian primitives using the fused BEV representation, the Gaussian primitives representing objects in the three-dimensional space; and project the Gaussian primitives into the BEV representation using Gaussian splatting to form an enhanced BEV representation of the three-dimensional space.

Clause 11: The device of clause 10, wherein to generate the Gaussian primitives, the processing system is configured to, for each of the Gaussian primitives, calculate a mean value and a covariance matrix.

Clause 12: The device of clause 11, wherein to form the fused BEV representation, the processing system is configured to perform feature extraction using the sensor input to extract features representing positions of objects in the three-dimensional space, and wherein to generate the Gaussian primitives, the processing system is configured to, for each of the features, calculate the mean value as a central position of the feature and the covariance matrix as a representation of uncertainty around the mean value.

Clause 13: The device of clause 11, wherein to generate the Gaussian primitives, the processing system is configured to, for each region of a set of regions of the three-dimensional space: determine a local complexity of the region; determine a subset of the features in the region; and for each of the subset of the features in the region, deform the covariance matrix for the feature according to the local complexity of the region.

Clause 14: The device of clause 10, wherein to generate the Gaussian primitives, the processing system is configured to: determine input features from at least one of the sensor input or the fused BEV representation; extract high-level feature maps from the input features; progressively downsample the high-level feature maps to form a set of downsampled feature maps; encode the set of downsampled feature maps to form an encoded feature map including encoded features of the objects in the three-dimensional space; and decode the encoded feature map, including progressively upsample the encoded feature map to an original resolution of the three-dimensional space and, during the decoding, predict the Gaussian primitives.

Clause 15: The device of clause 14, wherein the processing system includes a decoding including one or more self-attention layers, and wherein the decoder is configured to use previously determined Gaussian primitives as context in the self-attention layers.

Clause 16: The device of clause 15, wherein the processing system is further configured to calculate a binary mask from the Gaussian primitives based on a threshold for the Gaussian primitives, and wherein the self-attention layers are configured to modulate the input features using the binary mask.

Clause 17: The device of clause 10, wherein the processing system is further configured to at least partially autonomously control a vehicle using the enhanced BEV representation.

Clause 18: The device of clause 10, wherein the processing system is further configured to update the enhanced BEV representation over time based on updated sensor input from the set of sensors and updated Gaussian primitives from the updated sensor input.

Clause 19: A device for processing media data, the device comprising: means for receiving sensor input from a set of sensors, the sensor input including one or more images of a three-dimensional space around the set of sensors and a point cloud representation of the three-dimensional space; means for forming a fused bird's eye view (BEV) representation of the three-dimensional space from the one or more images and the point cloud representation; means for generating Gaussian primitives using the fused BEV representation, the Gaussian primitives representing objects in the three-dimensional space; and means for projecting the Gaussian primitives into the BEV representation using Gaussian splatting to form an enhanced BEV representation of the three-dimensional space.

Clause 20: The device of clause 19, wherein the means for generating the Gaussian primitives comprises: means for determining input features from at least one of the sensor input or the fused BEV representation; means for extracting high-level feature maps from the input features; means for progressively downsampling the high-level feature maps to form a set of downsampled feature maps; means for encoding the set of downsampled feature maps to form an encoded feature map including encoded features of the objects in the three-dimensional space; and means for decoding the encoded feature map, including means for progressively upsampling the encoded feature map to an original resolution of the three-dimensional space and means for predicting, during the decoding, the Gaussian primitives.

Clause 21: A method of processing media data, the method comprising: receiving sensor input from a set of sensors, the sensor input including one or more images of a three-dimensional space around the set of sensors and a point cloud representation of the three-dimensional space; forming a fused bird's eye view (BEV) representation of the three-dimensional space from the one or more images and the point cloud representation; generating Gaussian primitives using the fused BEV representation, the Gaussian primitives representing objects in the three-dimensional space; and projecting the Gaussian primitives into the BEV representation using Gaussian splatting to form an enhanced BEV representation of the three-dimensional space.

Clause 22: The method of clause 21, wherein generating the Gaussian primitives comprises, for each of the Gaussian primitives, calculating a mean value and a covariance matrix.

Clause 23: The method of clause 22, wherein forming the fused BEV representation comprises performing feature extraction using the sensor input to extract features representing positions of objects in the three-dimensional space, and wherein generating the Gaussian primitives comprises, for each of the features, calculating the mean value as a central position of the feature and the covariance matrix as a representation of uncertainty around the mean value.

Clause 24: The method of any of clauses 21 and 22, wherein generating the Gaussian primitives comprises, for each region of a set of regions of the three-dimensional space: determining a local complexity of the region; determining a subset of the features in the region; and for each of the subset of the features in the region, deforming the covariance matrix for the feature according to the local complexity of the region.

Clause 25: The method of any of clauses 21-24, wherein generating the Gaussian primitives comprises: determining input features from at least one of the sensor input or the fused BEV representation; extracting high-level feature maps from the input features; progressively downsampling the high-level feature maps to form a set of downsampled feature maps; encoding the set of downsampled feature maps to form an encoded feature map including encoded features of the objects in the three-dimensional space; and decoding the encoded feature map, including progressively upsampling the encoded feature map to an original resolution of the three-dimensional space and, during the decoding, predicting the Gaussian primitives.

Clause 26: The method of clause 25, wherein decoding the encoded feature map comprises decoding, by one or more self-attention layers of a decoder, the method further comprising using previously determined Gaussian primitives as context in the self-attention layers of the decoder.

Clause 27: The method of clause 26, further comprising: calculating a binary mask from the Gaussian primitives based on a threshold for the Gaussian primitives; and modulating, by the self-attention layers, the input features using the binary mask.

Clause 28: The method of any of clauses 21-27, further comprising at least partially autonomously controlling a vehicle using the enhanced BEV representation.

Clause 29: The method of any of clauses 21-28, further comprising updating the enhanced BEV representation over time based on updated sensor input from the set of sensors and updated Gaussian primitives from the updated sensor input.

Clause 30: A device for processing media data, the device comprising: a memory for storing media data; and a processing system comprising one or more processors implemented in circuitry, the processing system being configured to: receive sensor input from a set of sensors, the sensor input including one or more images of a three-dimensional space around the set of sensors and a point cloud representation of the three-dimensional space; form a fused bird's eye view (BEV) representation of the three-dimensional space from the one or more images and the point cloud representation; generate Gaussian primitives using the fused BEV representation, the Gaussian primitives representing objects in the three-dimensional space; and project the Gaussian primitives into the BEV representation using Gaussian splatting to form an enhanced BEV representation of the three-dimensional space.

Clause 31: The device of clause 30, wherein to generate the Gaussian primitives, the processing system is configured to, for each of the Gaussian primitives, calculate a mean value and a covariance matrix.

Clause 32: The device of clause 31, wherein to form the fused BEV representation, the processing system is configured to perform feature extraction using the sensor input to extract features representing positions of objects in the three-dimensional space, and wherein to generate the Gaussian primitives, the processing system is configured to, for each of the features, calculate the mean value as a central position of the feature and the covariance matrix as a representation of uncertainty around the mean value.

Clause 33: The device of any of clauses 30-32, wherein to generate the Gaussian primitives, the processing system is configured to, for each region of a set of regions of the three-dimensional space: determine a local complexity of the region; determine a subset of the features in the region; and for each of the subset of the features in the region, deform the covariance matrix for the feature according to the local complexity of the region.

Clause 34: The device of any of clauses 31-33, wherein to generate the Gaussian primitives, the processing system is configured to: determine input features from at least one of the sensor input or the fused BEV representation; extract high-level feature maps from the input features; progressively downsample the high-level feature maps to form a set of downsampled feature maps; encode the set of downsampled feature maps to form an encoded feature map including encoded features of the objects in the three-dimensional space; and decode the encoded feature map, including progressively upsample the encoded feature map to an original resolution of the three-dimensional space and, during the decoding, predict the Gaussian primitives.

Clause 35: The device of clause 34, wherein the processing system includes a decoding including one or more self-attention layers, and wherein the decoder is configured to use previously determined Gaussian primitives as context in the self-attention layers.

Clause 36: The device of clause 35, wherein the processing system is further configured to calculate a binary mask from the Gaussian primitives based on a threshold for the Gaussian primitives, and wherein the self-attention layers are configured to modulate the input features using the binary mask.

Clause 37: The device of clause any of clauses 31-36, wherein the processing system is further configured to at least partially autonomously control a vehicle using the enhanced BEV representation.

Clause 38: The device of any of clauses 31-37, wherein the processing system is further configured to update the enhanced BEV representation over time based on updated sensor input from the set of sensors and updated Gaussian primitives from the updated sensor input.

Clause 39: A method of processing image and depth data, the method comprising: receiving, from a multi-camera system of a vehicle, one or more images of a three-dimensional space around the vehicle; receiving, from a depth sensing unit of the vehicle, point cloud data representing the three-dimensional space; forming an initial bird's eye view (BEV) representation of the three-dimensional space from the one or more images and the point cloud data; generating Gaussian primitives using the initial BEV representation, the Gaussian primitives representing features of objects in the three-dimensional space; and combining the Gaussian primitives with the initial BEV representation using Gaussian splatting to form an enhanced BEV representation of the three-dimensional space.

Clause 40: The method of clause 39, wherein generating the Gaussian primitives comprises, for each of the Gaussian primitives, calculating a mean value and covariance data.

Clause 41: The method of clause 40, wherein forming the initial BEV representation comprises performing feature extraction using the sensor input to extract features representing positions of objects in the three-dimensional space, and wherein generating the Gaussian primitives comprises, for each of the features, calculating the mean value as a central position of the feature and the covariance data as a representation of uncertainty around the mean value.

Clause 42: The method of clause 41, wherein generating the Gaussian primitives comprises, for each region of a set of regions of the three-dimensional space: determining a local complexity of the region based on one or more characteristics associated with at least one of the region, the multi-camera system, the depth sensing unit, or a context of the vehicle; determining a subset of the features in the region; and for each of the subset of the features in the region, adapting the covariance data for the features according to the local complexity of the region.

Clause 43: The method of clause 39, wherein generating the Gaussian primitives comprises: determining input features from at least one of the initial BEV representation or the one or more images and the point cloud data; extracting high-level feature maps from the input features; progressively downsampling the high-level feature maps to form a set of downsampled feature maps; encoding the set of downsampled feature maps to form an encoded feature map including encoded features of the objects in the three-dimensional space; and decoding the encoded feature map, including progressively upsampling the encoded feature map to an original resolution of the three-dimensional space and, during the decoding, predicting the Gaussian primitives.

Clause 44: The method of clause 43, wherein decoding the encoded feature map comprises decoding, by one or more self-attention layers of a decoder, the method further comprising using previously determined Gaussian primitives as context in the self-attention layers of the decoder.

Clause 45: The method of clause 44, further comprising: calculating a binary mask from the Gaussian primitives based on a threshold for the Gaussian primitives; and modulating, by the one or more self-attention layers, the input features using the binary mask.

Clause 46: The method of clause 39, further comprising at least partially autonomously controlling the vehicle using the enhanced BEV representation.

Clause 47: The method of clause 39, further comprising updating the enhanced BEV representation over time based on updated images from the multi-camera system, updated point cloud data from the depth sensing unit, and updated Gaussian primitives from the updated images and the updated point cloud data.

Clause 48: A device for processing image and depth data, the device comprising: a memory for storing media data; and a processing system comprising one or more processors implemented in circuitry, the processing system being configured to: receive, from a multi-camera system of a vehicle, one or more images of a three-dimensional space around the vehicle; receive, from a depth sensing unit of the vehicle, point cloud data representing the three-dimensional space; form an initial bird's eye view (BEV) representation of the three-dimensional space from the one or more images and the point cloud data; generate Gaussian primitives using the initial BEV representation, the Gaussian primitives representing features of objects in the three-dimensional space; and combine the Gaussian primitives into the BEV representation using Gaussian splatting to form an enhanced BEV representation of the three-dimensional space.

Clause 49: The device of clause 48, wherein to generate the Gaussian primitives, the processing system is configured to, for each of the Gaussian primitives, calculate a mean value and covariance data.

Clause 50: The device of clause 49, wherein to form the initial BEV representation, the processing system is configured to perform feature extraction using the sensor input to extract features representing positions of objects in the three-dimensional space, and wherein to generate the Gaussian primitives, the processing system is configured to, for each of the features, calculate the mean value as a central position of the feature and the covariance data as a representation of uncertainty around the mean value.

Clause 51: The device of clause 49, wherein to generate the Gaussian primitives, the processing system is configured to, for each region of a set of regions of the three-dimensional space: determine a local complexity of the region based on one or more characteristics associated with at least one of the region, the multi-camera system, the depth sensing unit, or a context of the vehicle; determine a subset of the features in the region; and for each of the subset of the features in the region, adapt the covariance data for the features according to the local complexity of the region.

Clause 52: The device of clause 48, wherein to generate the Gaussian primitives, the processing system is configured to: determine input features from at least one of the initial BEV representation or the one or more images and the point cloud data; extract high-level feature maps from the input features; progressively downsample the high-level feature maps to form a set of downsampled feature maps; encode the set of downsampled feature maps to form an encoded feature map including encoded features of the objects in the three-dimensional space; and decode the encoded feature map, including progressively upsample the encoded feature map to an original resolution of the three-dimensional space and, during the decoding, predict the Gaussian primitives.

Clause 53: The device of clause 52, wherein the processing system includes a decoder including one or more self-attention layers, and wherein the decoder is configured to use previously determined Gaussian primitives as context in the one or more self-attention layers.

Clause 54: The device of clause 53, wherein the processing system is further configured to calculate a binary mask from the Gaussian primitives based on a threshold for the Gaussian primitives, and wherein the one or more self-attention layers are configured to modulate the input features using the binary mask.

Clause 55: The device of clause 48, wherein the processing system is further configured to at least partially autonomously control the vehicle using the enhanced BEV representation.

Clause 56: The device of clause 48, wherein the processing system is further configured to update the enhanced BEV representation over time based on updated images from the multi-camera system, updated point cloud data from the depth sensing unit, and updated Gaussian primitives from the updated images and the updated point cloud data.

Clause 57: A device for processing media data, the device comprising: means for receiving, from a multi-camera system of a vehicle, one or more images of a three-dimensional space around the vehicle; means for receiving, from a depth sensing unit of the vehicle, point cloud data representing the three-dimensional space; means for forming an initial bird's eye view (BEV) representation of the three-dimensional space from the one or more images and the point cloud data; means for generating Gaussian primitives using the initial BEV representation, the Gaussian primitives representing features of objects in the three-dimensional space; and means for combining the Gaussian primitives into the initial BEV representation using Gaussian splatting to form an enhanced BEV representation of the three-dimensional space.

Clause 58: The device of clause 57, wherein the means for generating the Gaussian primitives comprises: means for determining input features from at least one of the initial BEV representation or the one or more images and the point cloud data; means for extracting high-level feature maps from the input features; means for progressively downsampling the high-level feature maps to form a set of downsampled feature maps; means for encoding the set of downsampled feature maps to form an encoded feature map including encoded features of the objects in the three-dimensional space; and means for decoding the encoded feature map, including means for progressively upsampling the encoded feature map to an original resolution of the three-dimensional space and means for predicting, during the decoding, the Gaussian primitives.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing image and depth data, the method comprising:
receiving, from a multi-camera system of a vehicle, one or more images of a three-dimensional space around the vehicle;
receiving, from a depth sensing unit of the vehicle, point cloud data representing the three-dimensional space;
forming an initial bird's eye view (BEV) representation of the three-dimensional space from the one or more images and the point cloud data;
generating Gaussian primitives using the initial BEV representation, the Gaussian primitives representing features of objects in the three-dimensional space; and
combining the Gaussian primitives with the initial BEV representation using Gaussian splatting to form an enhanced BEV representation of the three-dimensional space.

2. The method of claim 1, wherein generating the Gaussian primitives comprises, for each of the Gaussian primitives, calculating a mean value and covariance data.

3. The method of claim 2, wherein forming the initial BEV representation comprises performing feature extraction using the sensor input to extract features representing positions of objects in the three-dimensional space, and wherein generating the Gaussian primitives comprises, for each of the features, calculating the mean value as a central position of the feature and the covariance data as a representation of uncertainty around the mean value.

4. The method of claim 2, wherein generating the Gaussian primitives comprises, for each region of a set of regions of the three-dimensional space:
determining a local complexity of the region based on one or more characteristics associated with at least one of the region, the multi-camera system, the depth sensing unit, or a context of the vehicle;
determining a subset of the features in the region; and
for each of the subset of the features in the region, adapting the covariance data for the features according to the local complexity of the region.

5. The method of claim 1, wherein generating the Gaussian primitives comprises:
determining input features from at least one of the initial BEV representation or the one or more images and the point cloud data;
extracting high-level feature maps from the input features;
progressively downsampling the high-level feature maps to form a set of downsampled feature maps;
encoding the set of downsampled feature maps to form an encoded feature map including encoded features of the objects in the three-dimensional space; and
decoding the encoded feature map, including progressively upsampling the encoded feature map to an original resolution of the three-dimensional space and, during the decoding, predicting the Gaussian primitives.

6. The method of claim 5, wherein decoding the encoded feature map comprises decoding, by one or more self-attention layers of a decoder, the method further comprising using previously determined Gaussian primitives as context in the self-attention layers of the decoder.

7. The method of claim 6, further comprising:
calculating a binary mask from the Gaussian primitives based on a threshold for the Gaussian primitives; and
modulating, by the one or more self-attention layers, the input features using the binary mask.

8. The method of claim 1, further comprising at least partially autonomously controlling the vehicle using the enhanced BEV representation.

9. The method of claim 1, further comprising updating the enhanced BEV representation over time based on updated images from the multi-camera system, updated point cloud data from the depth sensing unit, and updated Gaussian primitives from the updated images and the updated point cloud data.

10. A device for processing image and depth data, the device comprising:
a memory for storing media data; and
a processing system comprising one or more processors implemented in circuitry, the processing system being configured to:
receive, from a multi-camera system of a vehicle, one or more images of a three-dimensional space around the vehicle;
receive, from a depth sensing unit of the vehicle, point cloud data representing the three-dimensional space;
form an initial bird's eye view (BEV) representation of the three-dimensional space from the one or more images and the point cloud data;
generate Gaussian primitives using the initial BEV representation, the Gaussian primitives representing features of objects in the three-dimensional space; and
combine the Gaussian primitives into the BEV representation using Gaussian splatting to form an enhanced BEV representation of the three-dimensional space.

11. The device of claim 10, wherein to generate the Gaussian primitives, the processing system is configured to, for each of the Gaussian primitives, calculate a mean value and covariance data.

12. The device of claim 11, wherein to form the initial BEV representation, the processing system is configured to perform feature extraction using the sensor input to extract features representing positions of objects in the three-dimensional space, and wherein to generate the Gaussian primitives, the processing system is configured to, for each of the features, calculate the mean value as a central position of the feature and the covariance data as a representation of uncertainty around the mean value.

13. The device of claim 11, wherein to generate the Gaussian primitives, the processing system is configured to, for each region of a set of regions of the three-dimensional space:
determine a local complexity of the region based on one or more characteristics associated with at least one of the region, the multi-camera system, the depth sensing unit, or a context of the vehicle;
determine a subset of the features in the region; and
for each of the subset of the features in the region, adapt the covariance data for the features according to the local complexity of the region.

14. The device of claim 10, wherein to generate the Gaussian primitives, the processing system is configured to:
determine input features from at least one of the initial BEV representation or the one or more images and the point cloud data;
extract high-level feature maps from the input features;
progressively downsample the high-level feature maps to form a set of downsampled feature maps;
encode the set of downsampled feature maps to form an encoded feature map including encoded features of the objects in the three-dimensional space; and
decode the encoded feature map, including progressively upsample the encoded feature map to an original resolution of the three-dimensional space and, during the decoding, predict the Gaussian primitives.

15. The device of claim 14, wherein the processing system includes a decoder including one or more self-attention layers, and wherein the decoder is configured to use previously determined Gaussian primitives as context in the one or more self-attention layers.

16. The device of claim 15, wherein the processing system is further configured to calculate a binary mask from the Gaussian primitives based on a threshold for the Gaussian primitives, and wherein the one or more self-attention layers are configured to modulate the input features using the binary mask.

17. The device of claim 10, wherein the processing system is further configured to at least partially autonomously control the vehicle using the enhanced BEV representation.

18. The device of claim 10, wherein the processing system is further configured to update the enhanced BEV representation over time based on updated images from the multi-camera system, updated point cloud data from the depth sensing unit, and updated Gaussian primitives from the updated images and the updated point cloud data.

19. A device for processing media data, the device comprising:
means for receiving, from a multi-camera system of a vehicle, one or more images of a three-dimensional space around the vehicle;
means for receiving, from a depth sensing unit of the vehicle, point cloud data representing the three-dimensional space;
means for forming an initial bird's eye view (BEV) representation of the three-dimensional space from the one or more images and the point cloud data;
means for generating Gaussian primitives using the initial BEV representation, the Gaussian primitives representing features of objects in the three-dimensional space; and
means for combining the Gaussian primitives into the initial BEV representation using Gaussian splatting to form an enhanced BEV representation of the three-dimensional space.

20. The device of claim 19, wherein the means for generating the Gaussian primitives comprises:
means for determining input features from at least one of the initial BEV representation or the one or more images and the point cloud data;
means for extracting high-level feature maps from the input features;
means for progressively downsampling the high-level feature maps to form a set of downsampled feature maps;
means for encoding the set of downsampled feature maps to form an encoded feature map including encoded features of the objects in the three-dimensional space; and
means for decoding the encoded feature map, including means for progressively upsampling the encoded feature map to an original resolution of the three-dimensional space and means for predicting, during the decoding, the Gaussian primitives.
